(19) United States
(12) Patent Application Publication
(10) Pub. No.: US 2026/0088697 A1
(43) Pub. Date: Mar. 26, 2026

(54) PROJECTION DEVICE AND POWER CONVERSION DEVICE

(71) Applicant: Coretronic Corporation, Hsin-Chu (TW)

(72) Inventors: Chun-Hsin Cheng, Hsin-Chu (TW); Ying-Chieh Yeh, Hsin-Chu (TW); Tung-Min Lee, Hsin-Chu (TW)

(73) Assignee: Coretronic Corporation, Hsin-Chu (TW)

(21) Appl. No.: 19/329,517

(22) Filed: Sep. 15, 2025

Related U.S. Application Data
(60) Provisional application No. 63/698,049, filed on Sep. 24, 2024.

(30) Foreign Application Priority Data
Dec. 3, 2024 (CN) 202411759958.9

(51) Int. Cl. H02M 1/00; G03B 21/14; H02M 5/458

(52) U.S. Cl. CPC H02M 1/0019; G03B 21/14; H02M 1/0032; H02M 1/0083; H02M 5/4585

(57) ABSTRACT

Disclosed are a projection apparatus and a power conversion device. The power conversion device includes a transformer, a control circuit, and a feedback module. The transformer transforms a DC voltage to output a first voltage via an auxiliary output terminal and a second voltage via a secondary output terminal. The second voltage is greater than the first voltage. The feedback module receives a mode control signal and generates a feedback signal according to the first voltage output from the auxiliary output terminal and the second voltage output from the secondary output terminal. Responding to the mode control signal corresponding to a first mode, the feedback signal changes according to the first voltage. Responding to the mode control signal corresponding to a second mode, the feedback signal changes according to the second voltage. The control circuit generates a feedback voltage to a primary input terminal according to the feedback signal.

### CROSS-REFERENCE TO RELATED APPLICATION

This application claims the priority benefit of U.S. provisional application serial no. 63/698,049, filed on September 24, 2024 and China application serial no. 202411759958.9, filed on December 3, 2024. The entirety of the above-mentioned patent applications is hereby incorporated by reference herein and made a part of this specification.

### BACKGROUND

### Technical Field

The disclosure relates to a conversion device, and in particular to a projection device and a power conversion device.

### Related Art

Due to the miniaturization of household 3C products and the requirements of energy-saving regulations, the power structure of general household 3C products may be divided into main power, secondary power, and standby power. In the standby state, the standby power needs to supply the minimum power for the basic load according to regulatory requirements. After power-on, the main power serves as the primary power supply source, while the secondary power serves as an auxiliary power supply, making the product to provide full functional operation.

To reduce space and cost, two transformers with independent outputs configured to provide main power, secondary power, and standby power may be simplified into a single transformer with dual windings, and the dual feedback system may correspondingly be simplified from two to one. The existing feedback control only detects a single output voltage as the basis for feedback, which may achieve the effect of output voltage stabilization, but may not simultaneously meet the required voltage precision for different loads.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

A power conversion device of the disclosure includes a transformer, a first switch element, a control circuit, and a feedback module. The transformer includes a primary side input terminal, a secondary side output terminal, and an auxiliary output terminal. The primary side input terminal is configured to receive a DC voltage, the transformer transforms the DC voltage to output a first voltage via the auxiliary output terminal and a second voltage via the secondary side output terminal. The second voltage is greater than the first voltage. The first switch element is coupled between the transformer and a ground terminal. The control circuit is coupled to a control terminal of the first switch element. The feedback module is coupled to the secondary side output terminal, the auxiliary output terminal, and the control circuit. The feedback module is configured to receive a mode control signal, and generate a feedback signal according to the first voltage output from the auxiliary output terminal and the second voltage output from the secondary side output terminal. In response to the mode control signal corresponding to a first mode, the feedback signal changes according to the first voltage. In response to the mode control signal corresponding to a second mode, the feedback signal changes according to the second voltage. The control circuit receives the feedback signal from the feedback module, a conductive state of the first switch element is switched according to the feedback signal, and a feedback voltage is generated to the primary side input terminal according to the feedback signal.

This disclosure also provides a projection device, which includes the aforementioned power conversion device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 and FIG. 2 are schematic diagrams of a projection device according to an embodiment of the disclosure.

FIG. 3 is a schematic diagram of a feedback detection circuit according to an embodiment of the disclosure.

### DESCRIPTION OF THE EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted”, and variations thereof herein are used broadly and encompass direct and indirect connections, couplings, and mountings.

This disclosure provides a projection device and a power conversion device, which may meet the demand for precise control of output voltage for different loads.

Other objectives and advantages of the disclosure may be further understood from the technical features described in the disclosure.

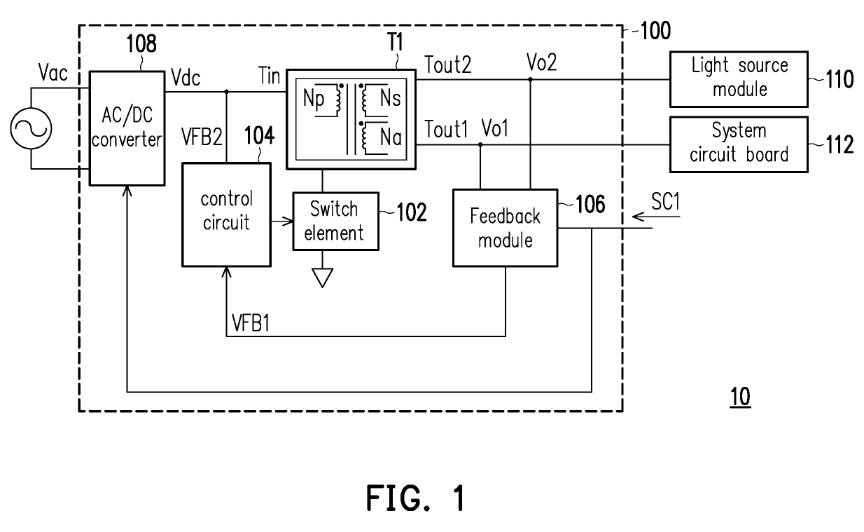

FIG. 1 is a schematic diagram of a projection device according to an embodiment of this disclosure. Referring to FIG. 1, a projection device 10 may include a power conversion device 100, a light source module 110, and a system circuit board 112. The power conversion device 100 is coupled to the light source module 110 and the system circuit board 112. The power conversion device 100 may provide a first voltage Vo1 and a second voltage Vo2 to the correspondingly coupled system circuit board 112 and light source module 110, respectively, to drive the light source module 110 to provide illumination beams and to provide the power needed for the operation of the system circuit board 112.

Furthermore, the power conversion device 100 may include a transformer T1, a first switch element 102, a control circuit 104, a feedback module 106, and an AC/DC converter 108. The transformer T1 includes a primary input terminal Tin, a secondary output terminal Tout2, and an auxiliary output terminal Tout1. The primary input terminal Tin is configured to receive a DC voltage Vdc. After transforming the DC voltage Vdc, the transformer T1 outputs the first voltage Vo1 via the auxiliary output terminal Tout1 and outputs the second voltage Vo2 via the secondary output terminal Tout2. Specifically, an internal of the transformer T1 includes a primary winding Np, a secondary winding Ns, and an auxiliary winding Na. The primary winding Np is coupled to the primary input terminal Tin, the secondary winding Ns is coupled to the secondary output terminal Tout2, and the auxiliary winding Na is coupled to the auxiliary output terminal Tout1. After entering the transformer T1 via the primary input terminal Tin, the DC voltage Vdc is modulated by the transformer T1 to output the first voltage Vo1 and the second voltage Vo2 respectively. Values of the first voltage Vo1 and the second voltage Vo2 are related to turn ratios of the auxiliary winding Na and the secondary winding Ns relative to the primary winding Np, respectively, and thus have corresponding proportional relationships with the DC voltage Vdc. The transformation of the DC voltage Vdc by the transformer T1 may be instructed by existing technology, which is not elaborated here.

The AC/DC converter 108 is coupled to the primary input terminal Tin of the transformer T1. The first switch element 102 is coupled between the primary winding Np of the transformer T1 and the ground terminal. The control circuit 104 may be, for example, a pulse width modulation controller, which is coupled to the primary input terminal Tin of the transformer T1 and a control terminal of the first switch element 102. The feedback module 106 is coupled to the secondary output terminal Tout2, the auxiliary output terminal Tout1 of the transformer T1, and the control circuit 104. The first switch element 102 is a power switch, which may be implemented as a transistor, for example, but is not limited thereto.

The AC/DC converter 108 may receive a mode control signal SC1, and convert the AC voltage Vac to generate the DC voltage Vdc according to the mode control signal SC1 to provide the DC voltage Vdc to the transformer T1. The control circuit 104 may switch a conductive state of the first switch element 102 to control the transformation of the received DC voltage Vdc by the transformer T1. After transforming the DC voltage Vdc, the transformer T1 outputs the first voltage Vo1 via the auxiliary output terminal Tout1 and the second voltage Vo2 via the secondary output terminal Tout2, wherein the second voltage Vo2 is greater than the first voltage Vo1. In an embodiment, the second voltage Vo2 may serve as the main power, while the first voltage Vo1 may serve as secondary power and/or standby power. For example, the light source module 110 of the projection device 10, which consumes the major power, may be coupled to the secondary output terminal Tout2 to receive the second voltage Vo2 with a higher voltage value to drive the light source module 110, while the system circuit board 112, which requires less power, may be coupled to the auxiliary output terminal Tout1 to receive the first voltage Vo1 with a lower voltage value to operate the system circuit board 112.

Moreover, the feedback module 106 is configured to receive the mode control signal SC1, and generate a feedback signal VFB1 according to the first voltage Vo1 output from the auxiliary output terminal Tout1 and the second voltage Vo2 output from the secondary output terminal Tout2. The control circuit 104 receives the feedback signal VFB1 from the feedback module 106, adjusts the conductive state of the first switch element 102 according to the feedback signal VFB1, for example, adjusting a duty ratio of a pulse width modulation signal given to the first switch element 102, and generates a feedback voltage VFB2 to the primary input terminal Tin of the transformer T1 according to the feedback signal VFB1.

In an embodiment, a first mode refers to a power-on mode of the projection device 10, and a second mode refers to a standby mode of the projection device 10. The mode control signal SC1 is generated in response to the user’s operation of the projection device 10 to give a power-on or standby command. In response to the mode control signal SC1 corresponding to the first mode, that is, in response to the projection device 10 entering the first mode, the feedback signal VFB1 changes according to the first voltage Vo1. In response to the mode control signal SC1 corresponding to the second mode, that is, in response to the projection device 10 entering the second mode, the feedback signal VFB1 changes according to the second voltage Vo2. In other words, when the projection device 10 enters the first mode, the change of the feedback signal VFB1 is mainly affected by the first voltage Vo1. For example, when the feedback signal VFB1 is generated in the first mode, a weight of the influence of the first voltage Vo1 on the feedback signal VFB1 may be greater than a weight of the influence of the second voltage Vo2 on the feedback signal VFB1. Similarly, when the projection device 10 enters the second mode, the change of the feedback signal VFB1 is mainly affected by the second voltage Vo2. For example, when the feedback signal VFB1 is generated in the second mode, a weight of the influence of the second voltage Vo2 on the feedback signal VFB1 may be greater than the weight of the influence of the first voltage Vo1 on the feedback signal VFB1. In the first mode, the ideal voltage values of the first voltage Vo1 and the second voltage Vo2 may be 52V and 12V respectively, for example. In the second mode, the ideal voltage values of the first voltage Vo1 and the second voltage Vo2 may be 44V and 7 to 10V respectively, for example, but are not limited thereto.

As such, changing the generation method of the feedback signal VFB1 corresponding to the mode switching of the mode control signal SC1 may satisfy the requirement of the power conversion device 100 to precisely control output voltages for different loads. For example, in the standby mode (the second mode), the feedback signal VFB1 is mainly affected by the second voltage Vo2, which may effectively and precisely control and stabilize the second voltage Vo2, avoiding excessive voltage fluctuation that may damage the downstream load (for example, the light source module 110). Meanwhile, the first voltage Vo1 is also maintained at a lower voltage due to the feedback control of the feedback module 106, which may reduce the voltage value provided to the downstream circuit (for example, the system circuit board 112) of the auxiliary output terminal Tout1, thereby improving efficiency and achieving the effect of reducing input power consumption. For instance, in the power-on mode (the first mode), the feedback signal VFB1 is mainly affected by the first voltage Vo1, enabling precise control of the first voltage Vo1 to provide a stable voltage to the downstream load (the system circuit board 112) of the auxiliary output terminal Tout1.

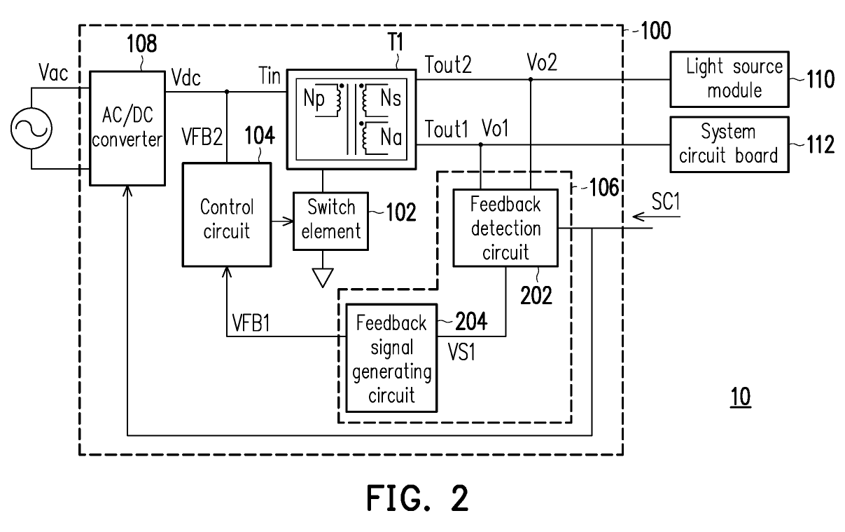

Furthermore, as shown in FIG. 2, the feedback module 106 may include a feedback detection circuit 202 and a feedback signal generating circuit 204. The feedback detection circuit 202 is coupled to the secondary output terminal Tout2 and the auxiliary output terminal Tout1 of the transformer T1, while the feedback signal generating circuit 204 is coupled to the feedback detection circuit 202 and the control circuit 104. The feedback detection circuit 202 is configured to receive the mode control signal SC1 and generate a feedback detection voltage VS1 according to the first voltage Vo1 and the second voltage Vo2. When the mode control signal SC1 corresponds to the first mode, the feedback detection voltage VS1 changes in response to the first voltage Vo1. When the mode control signal SC1 corresponds to the second mode, the feedback detection voltage VS1 changes in response to the second voltage Vo2. The feedback signal generating circuit 204 receives the feedback detection voltage VS1 from the feedback detection circuit 202 via an input terminal thereof, and generates the feedback signal VFB1 according to the feedback detection voltage VS1. The feedback signal VFB1 is then output to the control circuit 104 via the output terminal of the feedback signal generating circuit 204.

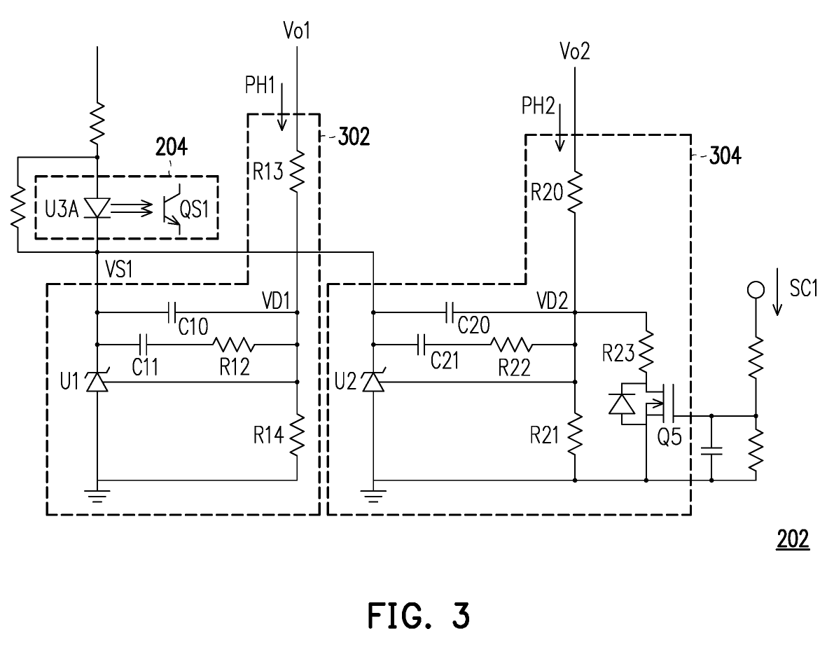

Specifically, as shown in FIG. 3, the feedback detection circuit 202 may include a first bleeder circuit 302 and a second bleeder circuit 304. The first bleeder circuit 302 is coupled to the auxiliary output terminal Tout1 and an input terminal of the feedback signal generating circuit 204. The first bleeder circuit 302 is configured to divide the first voltage Vo1 to generate and output a first divided voltage VD1 to the input terminal of the feedback signal generating circuit 204. The second bleeder circuit 304 is coupled to the secondary output terminal Tout2 and the input terminal of the feedback signal generating circuit 204. The second bleeder circuit 304 is configured to divide the second voltage Vo2 to generate and output a second divided voltage VD2 to the input terminal of the feedback signal generating circuit 204. The first divided voltage VD1 and the second divided voltage VD2 form the feedback detection voltage VS1 at the input terminal of the feedback signal generating circuit 204. The second bleeder circuit 304 adjusts the second divided voltage VD2 according to the mode control signal SC1.

In the embodiment of FIG. 3, the second bleeder circuit 304 may include multiple resistors R20, R21, R22, and R23, a second switch element Q5, multiple capacitors C20 and C21, and a zener diode U2. The resistor R20 is connected in series with the first resistor R21, and the resistor R20 and the first resistor R21 are coupled between the secondary output terminal Tout2 and a ground terminal. The second resistor R23 is connected in series with the second switch element Q5, and the second resistor R23 and the second switch element Q5 are coupled between the ground terminal and a common contact point of the resistor R20 and the first resistor R21, so that the second resistor R23 may be switchably connected in parallel with the first resistor R21. Specifically, the second switch element Q5 switches a conductive state according to the mode control signal SC1, making the second resistor R23 be connected in parallel with or disconnected from the first resistor R21. The second switch element Q5 may be implemented as a transistor, for example, but is not limited thereto. The capacitor C20 is coupled between the input terminal of the feedback signal generating circuit 204 and the common contact point of the resistor R20 and the first resistor R21. The capacitor C21 is connected in series with the resistor R22, and is coupled between the input terminal of the feedback signal generating circuit 204 and the common contact point of the resistor R20 and the first resistor R21. A cathode and an anode of the zener diode U2 are coupled to the input terminal of the feedback signal generating circuit 204 and the ground terminal, respectively. The zener diode U2 is also coupled to the common contact point of the resistor R20 and the first resistor R21.

The first bleeder circuit 302 may include multiple resistors R12, R13, and R14, multiple capacitors C10 and C11, and a zener diode U1. The resistor R13 is connected in series with the third resistor R14, and the resistor R13 and the third resistor R14 are coupled between the auxiliary output terminal Tout1 and the ground terminal. The capacitor C10 is coupled between the input terminal of the feedback signal generating circuit 204 and the common contact point of the resistor R13 and the third resistor R14. The capacitor C11 is connected in series with the resistor R12, and is coupled between the input terminal of the feedback signal generating circuit 204 and a common contact point of the resistor R13 and the third resistor R14. The cathode and the anode of the zener diode U1 are coupled to the input terminal of the feedback signal generating circuit 204 and the ground terminal, respectively. The zener diode U1 is also coupled to the common contact point of the resistor R13 and the third resistor R14. Furthermore, the feedback signal generating circuit 204 may be implemented as an optocoupler, for example, to isolate primary side and secondary side circuits of the transformer T1, and may include a light emitting diode U3A and a light sensing transistor QS1.

The first bleeder circuit 302 may provide a first divided voltage VD1 by dividing the first voltage Vo1 according to the resistor R13 and the third resistor R14. Thus, the first bleeder circuit 302 may provide the first divided voltage VD1 to the input terminal of the feedback signal generating circuit 204 through a first path PH1 (including the resistors R12 and R13, the third resistor R14, the capacitors C10 and C11, and the zener diode U1). Resistance values of the resistor R13 and the third resistor R14 may be, for example, 8.2K ohms and 2.082K ohms, respectively, but are not limited to thereto.

The second switch element Q5 may switch the conductive state controlled by the mode control signal SC1. For example, in response to the mode control signal SC1 corresponding to a first mode (the power-on mode), the second switch element Q5 is in conductive state, making the first resistor R21 and the second resistor R23 be connected in parallel. The second bleeder circuit 304 divides the second voltage Vo2 according to the resistor R20, the first resistor R21, and the second resistor R23, thereby generating a second divided voltage VD2. Thus, the second bleeder circuit 304 may provide the second divided voltage VD2 to the input terminal of the feedback signal generating circuit 204 through a second path PH2 (including the resistors R20 and R22, the first resistor R21, the second resistor R23, the capacitors C20 and C21, and the zener diode U2). In response to the mode control signal SC1 corresponding to a second mode (the standby mode), the second switch element Q5 is in non-conductive state, making the first resistor R21 and the second resistor R23 be disconnected. The second bleeder circuit 304 divides the second voltage Vo2 according to the resistor R20 and the first resistor R21, thereby generating the second divided voltage VD2. Thus, the second bleeder circuit 304 may provide the second divided voltage VD2 to the input terminal of the feedback signal generating circuit 204 through the second path PH2 (including the resistors R20 and R22, the first resistor R21, the capacitors C20 and C21, and the zener diode U2). In an embodiment, resistance values of the resistor R20, the first resistor R21, and the second resistor R23 may be, for example, 130K ohms, 7.7K ohms, and 27K ohms, respectively, but are not limited to thereto.

A voltage value of the feedback detection voltage VS1 is determined by the first divided voltage VD1 and the second divided voltage VD2. Since the second voltage Vo2 is greater than the first voltage Vo1, in the second mode, the feedback detection voltage VS1 is mainly affected by the second divided voltage VD2 (or mainly affected by the second voltage Vo2). In the first mode, due to the parallel connection of the first resistor R21 and the second resistor R23, the second resistor R23 is added to the second path PH2 to divide the second voltage Vo2, making a voltage value of the second divided voltage VD2 decrease, and thereby reducing influence on the feedback detection voltage VS1. Consequently, the feedback detection voltage VS1 may change from being mainly affected by the second divided voltage VD2 (or mainly affected by the second voltage Vo2) to being mainly affected by the first divided voltage VD1 (or mainly affected by the first voltage Vo1). Furthermore, the light emitting diode U3A of the feedback signal generating circuit 204 may emit light controlled by the feedback detection voltage VS1, and the light sensing transistor QS1 may sense the light emission of the light emitting diode U3A to generate the feedback signal VFB1. In other words, in the first mode, the feedback signal VFB1 may also change from being mainly affected by the second voltage Vo2 to being mainly affected by the first voltage Vo1.

In some embodiments, the resistance value of the first resistor R21 may be set to be greater than the resistance value of the third resistor R14, so that the rise time of the first voltage Vo1 may be greater than the rise time of the second voltage Vo2, making the control circuit 104 control the transformer T1 to provide a stable second voltage Vo2 to the light source module 110 quickly and precisely.

In summary, the feedback module of the disclosed embodiment may generate a feedback signal according to the first voltage output from the auxiliary output terminal of the transformer and the second voltage output from the secondary output terminal of the transformer. In response to the mode control signal corresponding to the first mode or the second mode, the feedback module may correspondingly change the feedback signal in response to the first voltage or the second voltage. By changing the generation method of the feedback signal in response to the mode switching of the mode control signal, the power conversion device may precisely control the output voltage for different loads to meet the requirements.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A power conversion device, comprising:
a transformer, comprising a primary side input terminal, a secondary side output terminal, and an auxiliary output terminal, wherein the primary side input terminal is configured to receive a DC voltage, the transformer transforms the DC voltage to output a first voltage via the auxiliary output terminal and a second voltage via the secondary side output terminal, and the second voltage is greater than the first voltage;
a first switch element, coupled between the transformer and a ground terminal;
a control circuit, coupled to a control terminal of the first switch element; and
a feedback module, coupled to the secondary side output terminal, the auxiliary output terminal, and the control circuit, wherein the feedback module is configured to receive a mode control signal, and to generate a feedback signal according to the first voltage output from the auxiliary output terminal and the second voltage output from the secondary side output terminal,
wherein, in response to the mode control signal corresponding to a first mode, the feedback signal changes according to the first voltage; and
in response to the mode control signal corresponding to a second mode, the feedback signal changes according to the second voltage;
wherein the control circuit receives the feedback signal from the feedback module, a conductive state of the first switch element is switched according to the feedback signal, and a feedback voltage is generated to the primary side input terminal according to the feedback signal.

2. The power conversion device according to claim 1, wherein the feedback module comprises:
a feedback detection circuit, coupled to the secondary side output terminal and the auxiliary output terminal, wherein the feedback detection circuit is configured to receive the mode control signal, and generate a feedback detection voltage according to the first voltage and the second voltage, and in response to the mode control signal corresponding to the first mode, the feedback detection voltage changes according to the first voltage, and in response to the mode control signal corresponding to the second mode, the feedback detection voltage changes according to the second voltage; and
a feedback signal generating circuit, coupled to the feedback detection circuit and the control circuit, wherein the feedback signal generating circuit receives the feedback detection voltage via an input terminal, and generates the feedback signal according to the feedback detection voltage, to output the feedback signal to the control circuit via an output terminal.

3. The power conversion device according to claim 2, wherein the feedback detection circuit comprises:
a first bleeder circuit, coupled to the auxiliary output terminal and the input terminal of the feedback signal generating circuit, wherein the first bleeder circuit is configured to divide the first voltage, and output a first divided voltage to the input terminal of the feedback signal generating circuit; and
a second bleeder circuit, coupled to the secondary side output terminal and the input terminal of the feedback signal generating circuit, wherein the second bleeder circuit is configured to divide the second voltage, and output a second divided voltage to the input terminal of the feedback signal generating circuit,
wherein the first divided voltage and the second divided voltage form the feedback detection voltage at the input terminal of the feedback signal generating circuit, and the second bleeder circuit adjusts the second divided voltage according to the mode control signal.

4. The power conversion device according to claim 3, wherein the second bleeder circuit comprises:
a first resistor, coupled between the secondary side output terminal and the ground terminal;
a second resistor, switchably connected in parallel with the first resistor; and
a second switch element, connected in series with the second resistor, wherein the second switch element is configured to switch a conductive state according to the mode control signal,
wherein, in response to the mode control signal corresponding to the first mode, the second switch element is in conductive state , making the second resistor be connected in parallel with the first resistor, and the second bleeder circuit divides the second voltage according to the first resistor and the second resistor, and
in response to the mode control signal corresponding to the second mode, the second switch element is in non-conductive state, making the second resistor be disconnected from the first resistor, and the second bleeder circuit divides the second voltage according to the first resistor.

5. The power conversion device according to claim 4, wherein the first bleeder circuit comprises:
a third resistor, coupled between the auxiliary output terminal and the ground terminal, wherein the first bleeder circuit divides the first voltage according to the third resistor.

6. The power conversion device according to claim 5, wherein a resistance value of the first resistor is greater than a resistance value of the third resistor.

7. The power conversion device according to claim 1, wherein a feedback signal generating circuit is an optocoupler.

8. The power conversion device according to claim 1, further comprising:
an AC/DC converter, coupled to the primary side input terminal of the transformer, wherein the AC/DC converter converts an AC voltage to the DC voltage and outputs the DC voltage to the transformer.

9. The power conversion device according to claim 8, wherein the AC/DC converter is configured to receive the mode control signal, and provide the DC voltage according to the mode control signal.

10. A projection device, comprising the power conversion device according to claim 1.

11. The projection device according to claim 10, wherein the first mode is a power-on mode of the projection device, and the second mode is a standby mode of the projection device.

12. The projection device according to claim 10, comprising a light source module, wherein the light source module is coupled to the secondary side output terminal of the power conversion device.

13. The projection device according to claim 10, comprising a system circuit board, wherein the system circuit board is coupled to the auxiliary output terminal of the power conversion device.
